(19) United States
(12) Patent Application Publication
(10) Pub. No.: US 2015/0140259 A1
(43) Pub. Date: May 21, 2015

(54) RADIO-WAVE TRANSPARENT COVER AND METHOD FOR MANUFACTURING RADIO-WAVE TRANSPARENT COVER

(71) Applicant: TOYODA GOSEI CO., LTD., Kiyosu-shi (JP)

(72) Inventors: Tatsuya SUGIURA, Kiyosu-shi (JP); Hideto MAEDA, Kiyosu-shi (JP); Daiichiro KAWASHIMA, Kiyosu-shi (JP)

(21) Appl. No.: 14/541,223

(22) Filed: Nov. 14, 2014

(30) Foreign Application Priority Data
Nov. 19, 2013 (JP) 2013-238773

(51) Int. Cl. B29C 45/00; B60R 13/00; B32B 3/08; B32B 3/30; B32B 27/08

(52) U.S. Cl. CPC B29C 45/0003; B32B 3/30; B32B 27/08; B32B 3/08; B60R 13/005; B32B 2307/412; B32B 2307/304; B32B 2451/00; B32B 2307/752; B29K 2033/08
USPC 428/72; 428/162; 428/161; 428/476.9; 264/255

(57) ABSTRACT

A radio-wave transparent cover is adapted to be arranged on a radio wave path of a radar device. The radio-wave transparent cover includes a transparent member, a decorative layer, a base, and a suppression member. The transparent member is formed of a first resin material. The decorative layer is formed on the rear surface of the transparent member. The base is formed of a second resin material and arranged behind the decorative layer. The suppression member is formed of a third resin material and molded in advance. The suppression member is arranged on the decorative layer to cover the rear surface of the decorative layer. The suppression member suppresses heat transfer to the transparent member when the base is insert-molded.

### BACKGROUND OF THE INVENTION

The present invention relates to a radio-wave transparent cover arranged on a radio wave path of a radar device and a method for manufacturing the radio-wave transparent cover.

Some recent vehicles employ a millimeter wave radar device to measure the distance and relative speed between the vehicles and nearby obstacles. The millimeter wave radar device is arranged behind a radiator grille or an emblem, which is provided in the front surface of a vehicle.

In many cases, radiator grilles and emblems include shiny metal surfaces formed through chromium plating to provide a quality appearance. However, a shiny metal surface hampers radio wave transmission, thus making it impossible to arrange a radiator grille or an emblem having the shiny metal surface at the front side of a millimeter wave radar device.

To solve this problem, it has been proposed to form an opening in a portion of a radiator grille located at the front side of a millimeter wave radar device and arrange a radio-wave transparent cover in the opening (Japanese Laid-Open Patent Publication No. 2000-159039, for example).

The cover described in the aforementioned document includes a transparent member formed of a resin material. A recessed groove is formed in the rear surface of the transparent member. A colored layer, such as a black layer, is formed in a flat portion of the rear surface of the transparent member. A shiny surface is formed on the recessed groove and the rear surface of the colored layer by vapor-depositing metal such as indium. A protective coating material is applied onto the rear surface of the shiny layer. A base formed of a resin material is insert-molded on the rear surface of the protective coating material. Since the shiny layer is covered by the protective coating material in the aforementioned manner, mechanical damage to the shiny layer is unlikely to happen when the base is insert-molded.

If the transparent member of the above-described conventional radio-wave transparent cover is formed of an acrylic resin having a relatively low heatproof temperature, the problem described below may occur. That is, when the base is insert-molded on the rear surface of the transparent member, heat is transferred from resin material in a heated molten state to the transparent member through the protective coating material or the shiny layer. This may cause thermal damage, such as whitening, in a portion of the transparent member, thus damaging the ornamental appearance of the radio-wave transparent cover.

### SUMMARY OF THE INVENTION

Accordingly, it is an objective of the present invention to provide a radio-wave transparent cover and a method for manufacturing the radio wave transparent cover that easily achieve a configuration for suppressing the occurrence of thermal damage in a transparent member during insert-molding of a base.

To achieve the foregoing objective, a radio-wave transparent cover adapted to be arranged on a radio wave path of a radar device is provided. The radio-wave transparent cover includes a transparent member formed of a first resin material, a decorative layer formed on a rear surface of the transparent member, a base formed of a second resin material and arranged behind the decorative layer, and a suppression member formed of a third resin material and molded in advance. The suppression member is arranged on the decorative layer to cover a rear surface of the decorative layer, and suppresses heat transfer to the transparent member when the base is insert-molded.

In this configuration, the suppression member, which is molded in advance, is arranged on the rear surface of the decorative layer to cover the rear surface of the decorative layer. Accordingly, when the base is insert-molded on the rear surface of the transparent member, heat transfer from the second resin material in a heated molten state to the transparent member is suppressed. The decorative layer and the transparent member are thus protected. As a result, thermal damage such as whitening is made unlikely to be caused by such heat transfer.

Also, in the configuration, by forming the decorative layer on the rear surface of the transparent member and then arranging the suppression member, which is molded in advance, on the decorative layer after, insert-molding the base is allowed to be carried out immediately afterwards. This shortens the time from when the decorative layer is formed to when the base is insert-molded.

To achieve the foregoing objective, a method for manufacturing a radio-wave transparent cover adapted to be arranged on a radio wave path of a radar device is also provided. The method includes: molding a transparent member using a first resin material; forming a decorative layer on a rear surface of the transparent member; molding a suppression member using a third resin material independently from the transparent member and the decorative layer; mounting the suppression member on a rear surface of the decorative layer to cover the rear surface of the decorative layer; and insert-molding a base on a rear surface of the suppression member using a second resin material.

According to this method, the suppression member, which is molded in advance, is arranged on the rear surface of the decorative layer to cover the rear surface of the decorative layer. Accordingly, when the base is insert-molded on the rear surface of the transparent member, heat transfer from the second resin material in a heated molten state to the transparent member is suppressed. The decorative layer and the transparent member are thus protected. As a result, thermal damage such as whitening is made unlikely to be caused by such heat transfer.

Also, according to the method, by forming the decorative layer on the rear surface of the transparent member and then arranging the suppression member, which is molded in advance, on the decorative layer, molding the base is allowed to carried out immediately afterwards. This shortens the time from when the decorative layer is formed to when the base is molded.

### BRIEF DESCRIPTION OF THE DRAWINGS

FIG. 1 is a plan view showing a radio-wave transparent cover according to one embodiment;

FIG. 2 is an enlarged cross-sectional taken along line 2-2 of FIG. 1;

FIG. 3 is an enlarged cross-sectional view showing a main portion of the radio-wave transparent cover of FIG. 1;

FIGS. 4A, 4B, and 4C are cross-sectional views each illustrating a part of a manufacturing step of the radio-wave transparent cover of FIG. 1;

FIGS. 5A, 5B, and 5C are cross-sectional views each illustrating a part of a manufacturing step of the radio-wave transparent cover performed subsequently to the manufacturing step illustrated in FIG. 4C; and

FIG. 6 is a cross-sectional view illustrating a part of a manufacturing step of a radio-wave transparent cover of a comparative example.

### DETAILED DESCRIPTION OF THE PREFERRED EMBODIMENTS

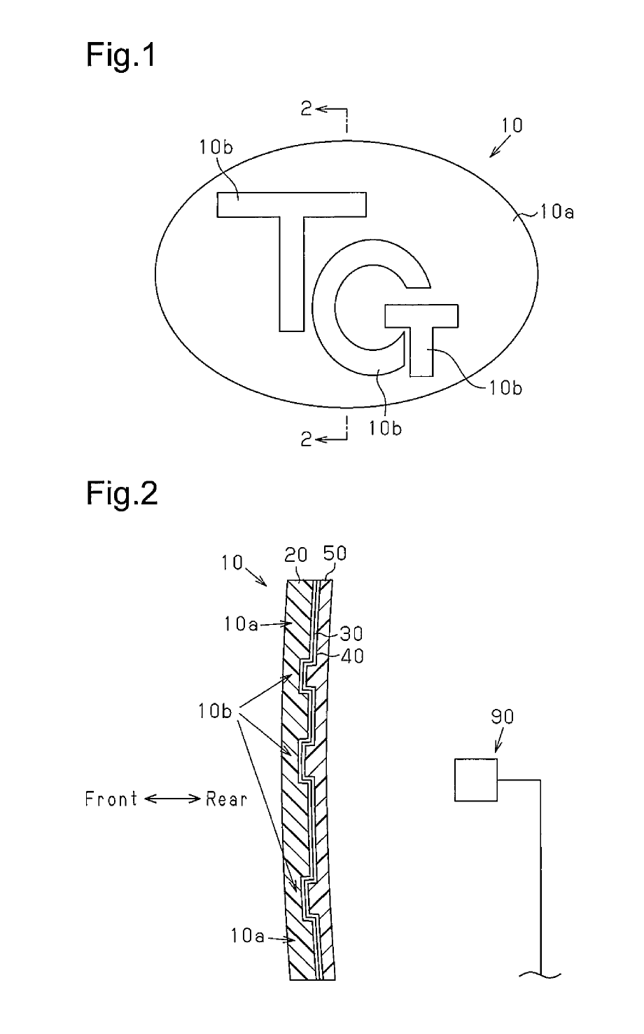

With reference to FIGS. 1 to 5C, a radio-wave transparent cover and a method for manufacturing the radio-wave transparent cover according to one embodiment will now be described. In the drawings, the components are represented in different scales so that they are recognizable, when necessary.

As illustrated in FIGS. 1 and 2, a radio-wave transparent cover (hereinafter, abbreviated as a cover 10) is an emblem attached to an opening of a front grille, which is arranged on a front surface of a vehicle. The cover 10 is located at the front side of a radar device 90 and arranged on a radio wave path of the radar device 90.

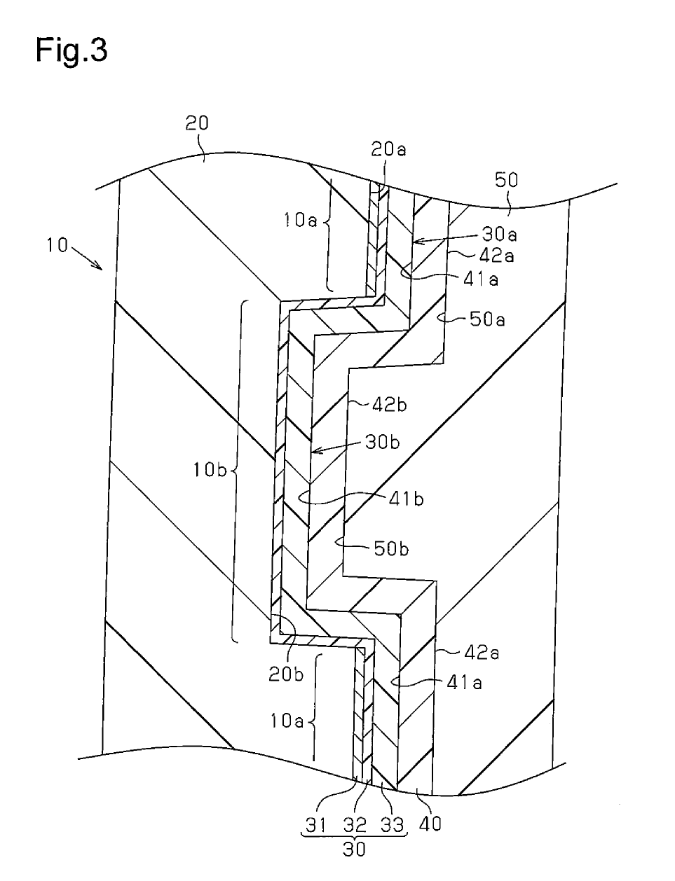

With reference to FIG. 2, the cover 10 has a transparent member 20 formed of an acrylic resin, which is an example of a first resin material. The transparent member 20 is formed of a polymethyl-methacrylate resin (PMMA resin), which exhibits particularly improved anti-wear performance. Referring to FIG. 3, the rear surface of the transparent member 20 includes a flat portion 20a and a recess 20b, which is formed in the flat portion 20a. The depth of the recess 20b is set to, for example, approximately 3.0 mm. The bottom surface of the recess 20b is arranged forward of the flat portion 20a. As illustrated in FIGS. 1 to 3, the flat portion 20a corresponds to a background zone 10a of the cover 10. The recess 20b corresponds to a character zone 10b of the cover 10.

As illustrated in FIGS. 2 and 3, a decorative layer 30 is formed on the rear surface of the transparent member 20. Referring to FIG. 3, the decorative layer 30 includes a colored layer 31, a shiny layer 32, and a corrosion suppressing layer 33. The colored layer 31 is formed on the flat portion 20a of the rear surface of the transparent member 20 through printing. The shiny layer 32 is formed by vapor-depositing metal material on the entire rear surface of the recess 20b of the transparent member 20 and the entire rear surface of the colored layer 31. The corrosion suppressing layer 33 is formed by coating the entire rear surface of the shiny layer 32. The colored layer 31 is, for example, black. The shiny layer 32 is formed of, for example, indium and has a thickness of approximately 20 nm, for example. The corrosion suppressing layer 33 suppresses corrosion of the shiny layer 32 and is formed of an acrylic or urethane resin material. The thickness of the corrosion suppressing layer 33 is, for example, approximately several tens of micrometers. The rear surface of the corrosion suppressing layer 33, or, in other words, the rear surface of the decorative layer 30, thus has a recess 30b corresponding to the recess 20b of the transparent member 20. The heatproof temperature of the corrosion suppressing layer 33 is approximately 200° C.

A suppression sheet 40 serving as a suppression member is arranged on the rear surface of the corrosion suppressing layer 33 to cover the entire rear surface of the corrosion suppressing layer 33. The suppression sheet 40 is shaped to correspond with the shape of the rear surface of the decorative layer 30. The front surface of the suppression sheet 40 has a flat portion 41a and a projection 41b. The flat portion 41a is held in tight contact with the flat portion 30a of the rear surface of the decorative layer 30. The projection 41b is held in tight contact with the recess 30b of the rear surface of the decorative layer 30. The suppression sheet 40 is formed of a polyamide resin, which is an example of a third resin material, and molded in advance. It is preferred that the thickness of the suppression sheet 40 be in the range of 0.1 mm to 1.0 mm. In the illustrated embodiment, the thickness of the suppression sheet 40 is approximately 0.6 mm. The heatproof temperature of the suppression sheet 40 is approximately 140° C. As will be described below, the suppression sheet 40 is deployed to suppress heat transfer to the transparent member 20 when a base 50 is insert-molded.

The base 50, which is formed of an acrylonitrile-ethylene-styrene copolymer resin (AES resin) serving as an example of a second resin material, is formed on the rear surface of the suppression sheet 40. The front surface of the base 50 is shaped in correspondence with the shape of the rear surface of the suppression sheet 40 and has a flat portion 50a and a projection 50b. The flat portion 50a is held in tight contact with a flat portion 42a of the rear surface of the suppression sheet 40. The projection 50b is held in tight contact with a recess 42b of the rear surface of the suppression sheet 40.

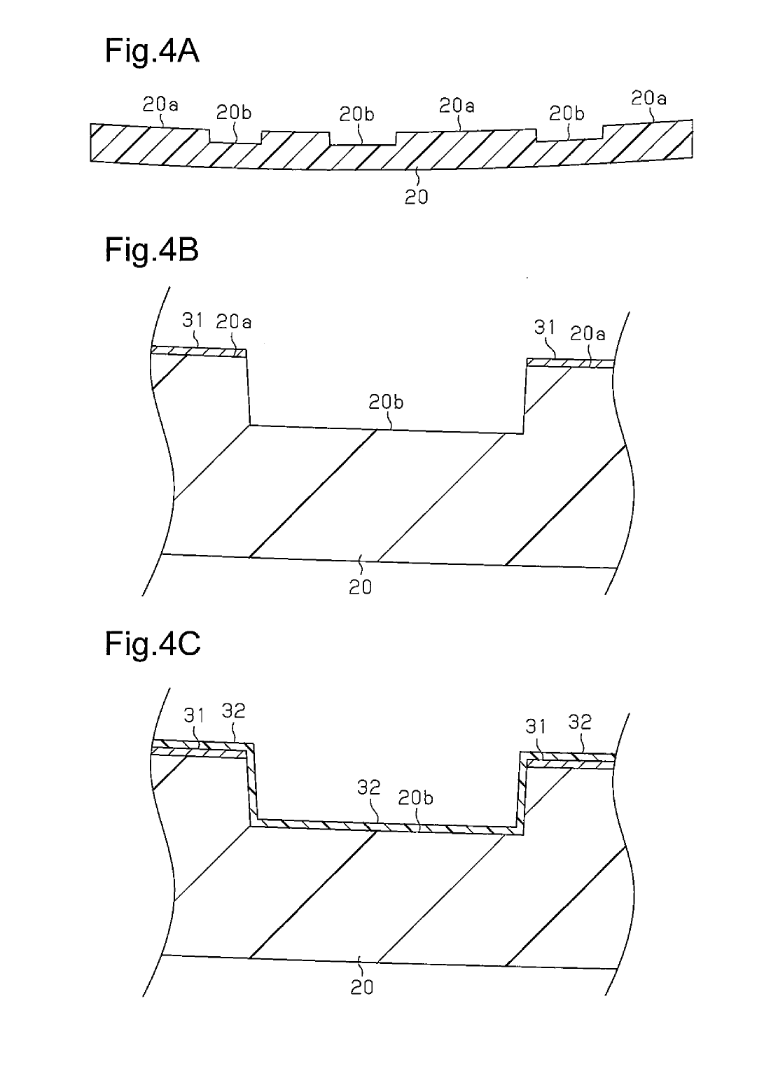

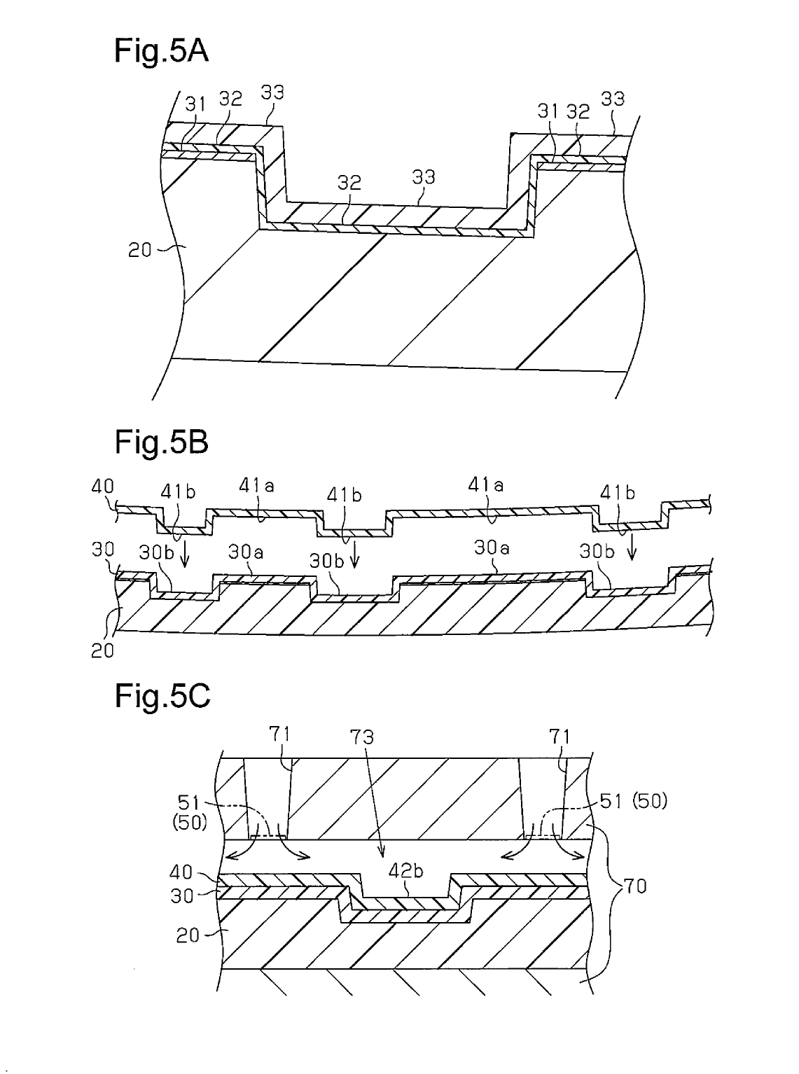

A method for manufacturing the cover 10 of the illustrated embodiment will hereafter be described with reference to FIGS. 4 and 5. In FIGS. 4 and 5, the upper side of each drawing corresponds to the rear side of the cover 10 and the lower side of the drawing corresponds to the front side of the cover 10.

As illustrated in FIG. 4A, to manufacture the cover 10, the transparent member 20 having the flat portion 20a and the recess 20b is first molded through injection molding (a transparent member molding step).

Subsequently, with reference to FIG. 4B, the colored layer 31 is formed on the flat portion 20a of the rear surface of the transparent member 20 through printing. Next, referring to FIG. 4C, the shiny layer 32 is formed by vapor-depositing metal material on the entire rear surface of the recess 20b of the transparent member 20 and the entire rear surface of the colored layer 31. Then, as illustrated in FIG. 5A, the entire rear surface of the shiny layer 32 is coated to form the corrosion suppressing layer 33. The steps illustrated in FIGS. 4B, 4C, 5A correspond to a decorative layer forming step.

Independently from the above-described transparent member molding step and decorative layer forming step, the suppression sheet 40 is hot-melt-molded (a suppression member molding step).

Then, with reference to FIG. 5B, the suppression sheet 40 is mounted on the rear surface of the decorative layer 30 to cover the rear surface of the decorative layer 30 (a suppression member mounting step). In other words, the projection 41b of the front surface of the suppression sheet 40 is inserted in the recess 30b of the rear surface of the decorative layer 30 such that the front surface of the projection 41b contacts the rear surface of the recess 30b. Also, the flat portion 41a of the front surface of the suppression sheet 40 is caused to contact the flat portion 30a of the rear surface of the decorative layer 30.

Subsequently, referring to FIG. 5C, the base 50 is insert-molded on the rear surface of the suppression sheet 40 by forming the decorative layer 30, providing the transparent member 20, on which the suppression sheet 40 is arranged, in a mold 70, and introducing the second resin material (in the illustrated embodiment, AES resin) in a molten state into the mold 70 through a plurality of gates 71 (a base molding step). The gates 71 are arranged to face the flat portion 41a of the front surface of the suppression sheet 40. Accordingly, as represented by the long dashed double-short dashed lines in FIG. 5C, gate marks 51 are generated at positions of the rear surface of the base 50 corresponding to the flat portion 41a in correspondence with the shapes of the openings of the gates 71.

Operation of the illustrated embodiment will hereafter be described through comparison between the embodiment and a cover of a comparative example. The cover of the comparative example is formed without a suppression sheet 40 but configured identically with the cover 10 of the illustrated embodiment except for the suppression sheet 40.

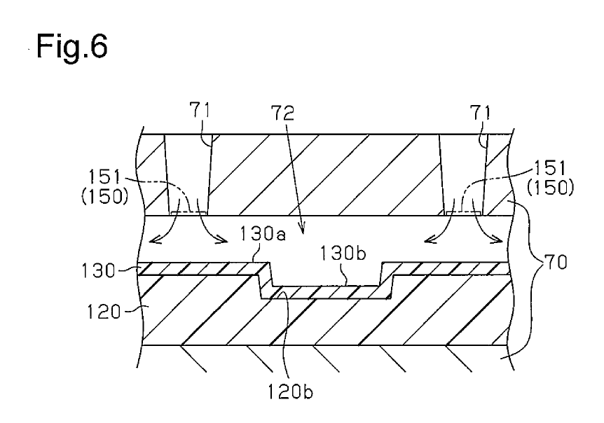

As illustrated in FIG. 6, in the case of the cover of the comparative example, when resin material in a heated molten state is poured into a recess 130b of a decorative layer 130 to insert-mold a base 150, gas cannot escape from the recess 130b and thus easily causes a temperature increase and a pressure rise in the recess 130b. The thus generated heat can easily cause thermal damage such as whitening in a transparent member 120. Also, since the recess 120b of the transparent member 120 does not have a colored layer and includes only a shiny layer, the layer thickness in the recess 130b is small compared to the layer thickness on the flat portion 130a. This decreases the effect of suppressing heat transfer to the transparent member 120 by the decorative layer 130 in the recess 120b of the transparent member 120. The transparent member 120 is thus thermally damaged easily.

Particularly, if the resin material in a heated molten state is introduced into a cavity 72 of a mold through a plurality of gates 71 to insert-mold the base 150 on the rear surface of the transparent member 120, resin material poured through one of the gates 71 strikes resin material provided through another one of the gates 71 in the cavity 72. At the position where the resin material strikes the resin material, gas cannot escape from the cavity 72 and is thus compressed. This easily brings about a temperature increase and a pressure rise, thus easily causing thermal damage in the transparent member 120. As a result, thermal damage is caused in the recess 120b of the transparent member 120, which is a portion corresponding to a portion between adjacent gate marks 151 formed on the rear surface of the base 150.

Similarly to the cover 10 of the illustrated embodiment, the cover of the comparative example has a corrosion suppressing layer formed on the rear surface of the shiny layer to suppress corrosion of the shiny layer. The corrosion suppressing layer suppresses heat transfer from the resin material in a heated molten state to the transparent member 120 to a certain extent. However, the thickness of the corrosion suppressing layer is as small as approximately several tens of micrometers and insufficient to protect the transparent member 120.

In contrast, in the cover 10 of the illustrated embodiment, the suppression sheet 40, which is molded in advance, is arranged on the rear surface of the decorative layer 30 to cover the entire rear surface of the decorative layer 30. Accordingly, when the base 50 is insert-molded, heat transfer from the second resin material in a heated molten state to the transparent member 20 is suppressed. This protects the decorative layer 30 and the transparent member 20. As a result, it is unlikely that thermal damage such as whitening will be caused in the transparent member 20 by the aforementioned heat transfer.

Also, in the cover 10 of the illustrated embodiment, by forming the decorative layer 30 on the rear surface of the transparent member 20 and then arranging the suppression sheet 40, which is molded in advance, on the decorative layer 30, insert-molding the base 50 is allowed to be carried out immediately afterwards. This shortens the time from when the decorative layer 30 is formed to when the base 50 is insert-molded.

The radio-wave transparent cover and the method for manufacturing the radio-wave transparent cover according to the illustrated embodiment have the advantages described below.

(1) The radio-wave transparent cover 10 is arranged on the radio wave path of the radar device 90 and includes the transparent member 20, the decorative layer 30, the base 50, and the suppression sheet 40 serving as a suppression member. The transparent member 20 is formed of the first resin material. The decorative layer 30 is formed on the rear surface of the transparent member 20. The base 50 is formed of the second resin material and arranged behind the decorative layer 30. The suppression sheet 40 is formed of the third resin material and molded in advance. The suppression sheet 40 is arranged on the decorative layer 30 to cover the rear surface of the decorative layer 30. When the base 50 is insert-molded, the suppression sheet 40 suppresses heat transfer to the transparent member 20.

In this configuration, when the base 50 is insert-molded, the suppression sheet 40 serving as the suppression member suppresses the heat transferred from the second resin material in a heated molten state to the transparent member 20 through the decorative layer 30. The decorative layer 30 and the transparent member 20 are thus protected. This makes it unlikely that such heat transfer will cause thermal damage such as whitening in the transparent member 20. Also, the configuration shortens the time from when the decorative layer 30 is formed to when the base 50 is insert-molded. As a result, the configuration that makes it unlikely that thermal damage is caused in the transparent member 20 when the base 50 is insert-molded is easily brought about.

(2) The rear surface of the transparent member 20 includes the flat portion 20a and the recess 20b. The decorative layer 30 is formed on the rear surface of the transparent member 20 and thus has the recess 30b, which is shaped similarly to the recess 20b of the transparent member 20. The suppression sheet 40 is arranged in the recess 30b of the decorative layer 30.

This configuration reliably protects the recess 20b, which can be thermally damaged easily in the transparent member 20.

(3) The rear surface of the transparent member 20 includes the flat portion 20a and the recess 20b. The decorative layer 30 is formed on the rear surface of the transparent member 20 and thus has the recess 30b, which is shaped similarly to the recess 20b of the transparent member 20. The decorative layer 30 includes the colored layer 31, which is formed on the flat portion 20a of the rear surface of the transparent member 20, and the shiny layer 32, which is formed on the rear surface of the recess 20b of the transparent member 20 and the rear surface of the colored layer 31. The suppression sheet 40 is arranged in the recess 30b of the decorative layer 30.

In this configuration, the decorative layer 30 includes a relatively thin portion, which does not have the colored layer 31, and a relatively thick portion, which includes the colored layer 31. The relatively thin portion is arranged in the recess 20b of the transparent member 20. The recess 30b, which is shaped similarly to the recess 20b of the transparent member 20, is thus formed in the decorative layer 30. The portion of the transparent member 20 corresponding to the relatively thin portion of the decorative layer 30 can be thermally damaged easily compared to the portion of the transparent member 20 corresponding to the relatively thick portion of the decorative layer 30. However, the suppression sheet 40 is arranged in the recess 30b of the decorative layer 30 to reliably protect the recess 20b, which can be thermally damaged easily in the transparent member 20.

(4) The decorative layer 30 is formed on the rear surface of the shiny layer 32 and includes the corrosion suppressing layer 33, which suppresses corrosion of the shiny layer 32. The suppression sheet 40 is arranged on the rear surface of the corrosion suppressing layer 33.

This configuration makes it unlikely that thermal damage will be caused in the transparent member 20 when the base 50 is insert-molded in the configuration in which the decorative layer 30 includes the corrosion suppressing layer 33.

(5) The suppression sheet 40 is arranged at positions between adjacent pairs of the gate marks 51, which are generated on the rear surface of the base 50 when the base 50 is molded.

This configuration reliably protects each portion of the transparent member 20 that can be thermally damaged easily.

(6) The decorative layer 30 is formed on the entire rear surface of the transparent member 20. The suppression sheet 40 covers the entire rear surface of the decorative layer 30.

This configuration needs only one suppression sheet 40, thus facilitating parts control. Also, when the suppression sheet 40 is arranged on the rear surface of the decorative layer 30, the suppression sheet 40 is easily positioned relative to the decorative layer 30.

(7) The first resin material is an acrylic resin. The acrylic resin exhibits improved weatherproof performance and enhanced anti-wear performance. Accordingly, if the transparent member 20 is formed of the acrylic resin as in the illustrated embodiment, coating for improving the anti-wear performance may be omitted and, also, the corresponding coating step may be omitted. However, the heatproof temperature of the acrylic resin is low compared to the heatproof temperature of a polycarbonate resin (PC resin) and starts to soften at approximately 80° C. This may easily cause thermal damage in the transparent member when the base is insert-molded.

However, in the illustrated embodiment, despite the fact that the transparent member 20 is formed of the acrylic resin, the suppression sheet 40 suppresses thermal damage in the transparent member 20 when the base 50 is insert-molded.

(8) The second resin material is an acrylonitrile-ethylene-styrene copolymer resin. The third resin material is a polyamide resin.

(9) The method for manufacturing the radio-wave transparent cover 10 is a method for manufacturing a cover arranged on a radio wave path of the radar device 90. The method includes the step of molding the transparent member 20 using the first resin material and the step of forming the decorative layer 30 on the rear surface of the transparent member 20. The method also includes the step of molding the suppression sheet 40 using the third resin material independently from the transparent member 20 and the decorative layer 30, the step of mounting the suppression sheet 40 on the rear surface of the decorative layer 30 to cover the rear surface of the decorative layer 30, and the step of insert-molding the base 50 on the rear surface of the suppression sheet 40 using the second resin material.

The above-described manufacturing method achieves an advantage similar to the advantage (1).

The radio-wave transparent cover and the method for manufacturing the radio-wave transparent cover according to the present invention are not restricted to the configurations of the illustrated embodiment but may be embodied in the forms described below, which are modified from the embodiment as needed.

In the illustrated embodiment, the colored layer 31 and the shiny layer 32 are formed directly on the rear surface of the transparent member 20. However, the colored layer 31 and the shiny layer 32 may be formed on the rear surface of the transparent member 20 after the rear surface of the transparent member 20 is coated.

In the illustrated embodiment, the transparent member 20 is formed of an acrylic resin as the first resin material. Instead, a transparent member formed of a polycarbonate resin may be employed.

The number and positions of the gates 71, which are used to insert-mold the base 50, are not restricted to the number and positions of the illustrated embodiment. In other words, only one gate or three or more gates may be employed.

In the illustrated embodiment, the single suppression sheet 40 covers the entire rear surface of the decorative layer 30. However, arrangement of the suppression member is not restricted to this. That is, the suppression member may cover a portion of the rear surface of the decorative layer. In other words, the suppression member may be arranged only in the recess of the rear surface of the decorative layer, for example. Also, thermal damage in the transparent member can be caused easily in portions corresponding to positions between adjacent gates for insert-molding the base. Accordingly, the suppression member may be arranged in the portions of the rear surface of the decorative layer corresponding to the aforementioned portions corresponding to the positions between adjacent gates.

If the suppression sheet 40 suppresses corrosion of the shiny layer 32, the corrosion suppressing layer 33 may be omitted.

The colored layer may be formed in the recess 20b of the rear surface of the transparent member 20 and the shiny layer may be formed on the rear surface of the flat portion 20a and the rear surface of the colored layer.

In the illustrated embodiment, the suppression member is formed of a polyamide resin serving as the third resin material. However, the present invention is not restricted to this. For example, the suppression member may be formed of a urethane resin or a polyethylene resin (PE resin). These materials are particularly suitable for hot-melt molding. Alternatively, the suppression member may be formed of a polyethylene terephthalate resin (PET resin), a polyimide resin (PI resin), a polyurethane resin (PU resin), or a polybutylene terephthalate resin (PBT resin). These materials exhibit improved heat resistance performance and are desirable as materials of suppression members.

1. A radio-wave transparent cover adapted to be arranged on a radio wave path of a radar device, the radio-wave transparent cover comprising:
a transparent member formed of a first resin material;
a decorative layer formed on a rear surface of the transparent member;
a base formed of a second resin material and arranged behind the decorative layer; and
a suppression member formed of a third resin material and molded in advance, wherein the suppression member is arranged on the decorative layer to cover a rear surface of the decorative layer, and suppresses heat transfer to the transparent member when the base is insert-molded.

2. The radio-wave transparent cover according to claim 1, wherein
the transparent member includes a flat portion and a recess formed in the rear surface of the transparent member,
the decorative layer has a recess that is formed in the rear surface of the transparent member and thus shaped similarly to the recess of the transparent member, and
the suppression member is arranged in the recess of the decorative layer.

3. The radio-wave transparent cover according to claim 1, wherein
the decorative layer has a relatively thick portion and a relatively thin portion, and
the suppression member is arranged in the relatively thin portion of the decorative layer.

4. The radio-wave transparent cover according to claim 3, wherein
the transparent member includes a flat portion and a recess formed in the rear surface of the transparent member,
the decorative layer has a recess that is formed in the rear surface of the transparent member and thus shaped similarly to the recess of the transparent member,
the decorative layer includes a colored layer formed on the flat portion of the rear surface of the transparent member and a shiny layer formed on both the rear surface of the recess of the transparent member and the rear surface of the colored layer, and
the suppression member is arranged in the recess of the decorative layer.

5. The radio-wave transparent cover according to claim 4, wherein
the decorative layer has a corrosion suppressing layer,
the corrosion suppressing layer is formed on a rear surface of the shiny layer to suppress corrosion of the shiny layer, and
the suppression member is arranged on a rear surface of the corrosion suppressing layer.

6. The radio-wave transparent cover according to claim 1, wherein the suppression member is arranged in a portion between a plurality of gate marks generated on a rear surface of the base when the base is molded.

7. The radio-wave transparent cover according to claim 1, wherein
the decorative layer is formed on the entire rear surface of the transparent member, and
the suppression member covers the entire rear surface of the decorative layer.

8. The radio-wave transparent cover according to claim 1, wherein the first resin material is acrylic resin.

9. The radio-wave transparent cover according to claim 8, wherein
the second resin material is acrylonitrile-ethylene-styrene copolymer resin, and
the third resin material is polyamide resin.

10. A method for manufacturing a radio-wave transparent cover adapted to be arranged on a radio wave path of a radar device, the method comprising:
molding a transparent member using a first resin material;
forming a decorative layer on a rear surface of the transparent member;
molding a suppression member using a third resin material independently from the transparent member and the decorative layer;
mounting the suppression member on a rear surface of the decorative layer to cover the rear surface of the decorative layer; and
insert-molding a base on a rear surface of the suppression member using a second resin material.

11. The method according to claim 10, wherein
the first resin material is acrylic resin,
the second resin material is acrylonitrile-ethylene-styrene copolymer resin, and
the third resin material is polyamide resin.
